(19) United States
(12) Patent Application Publication
(10) Pub. No.: US 2003/0086507 A1
(43) Pub. Date: May 8, 2003

(54) Peak limiting architecture and method

(76) Inventors: Jaehyeong Kim, Pine Brook, NJ (US); Kumud K. Sanwal, Iselin, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/037,051

(22) Filed: Nov. 7, 2001

(51) Int. Cl. H04L 25/03

(52) U.S. Cl. 375/297

(57) ABSTRACT

A method for softlimiting or clipping a signal. The method includes the step of searching for at least the highest peak above a threshold within a first window created from a set of samples of the signal. Thereafter, a threshold-correcting signal is added to the highest peak found.

### BACKGROUND OF THE INVENTION

I. Field of the Invention

The present invention relates to a device and method for limiting peaks of a signal and, more particularly, to a device and method for reducing the peak-to-average ratio (“PAR”) of an input signal without generating significant out-of-band emissions.

II. Description of the Related Art

Power amplifiers have non-linear characteristics. The cost of power amplifiers is determined by the size of their linear range. The non-linear characteristic of conventional power amplifiers causes out-of-band spectral artifacts, such as spectrum distortions, splatters, and spectrum spreading, for example. By reducing the peaks of an input signal to the power amplifier, the peak-to-average ratio (“PAR”) of the input signal may be reduced, thereby increasing the average power output by the amplifier.

One known method for reducing the PAR of an input signal involves hardlimiting. Hardlimiting the input signal clips the peaks of the input signal to a threshold lower than the PAR. By clipping the signal peaks, a noise-like signal is added to the input signal, thereby generating a hard clipped signal. For example, when an input signal is hardlimited by conventional clipping, the effect in the frequency domain is to add the spectrum of a noise-like signal to the input signal spectrum. The algorithm for generating the hard clipped signal is as follows:

If V_{IN}≧V_{CLIP}, then V_{OUT}=V_{CLIP}, or

If V_{IN}≦−V_{CLIP}, then V_{OUT}=−V_{CLIP},

else V_{OUT}=V_{IN},

wherein V_{IN} represents the input signal, V_{CLIP} represents a clipping threshold, and V_{OUT} represents the hard clipped signal.

A hard clipped signal has abrupt edges and sharp peaks. The abrupt nature of the hardlimiting process and the short time duration of clipped edges generate significant out-of-band spectral artifacts, such as adjacent channel power (“ACP”), spectrum distortions, spectrum spreading and splatter. A filter may be used to remove the out-of-band spectral artifacts, including the ACP. For a radio transmitter, the filter may be implemented at baseband or intermediate frequency (“IF”), where sharp filters are readily available in either digital or analog form. A digital implementation at baseband may be favored, however, because of its enhanced flexibility and lower cost. It has been found, however, that the signal peaks may return after filtering the clipped signal. Accordingly, the signals peaks may again be detected thereafter hardlimited to a new limit lower than the detection threshold.

One known hardlimiting technique for reducing the PAR of an input signal employs an attenuating scheme. Here, the attenuating scheme is centered about a local maximum of signal peak above a threshold such that the input signal is an attenuated. The attenuating scheme comprises multiple sample weights, each of which are valued at less than one. The multiple sample weights of the attenuating scheme are multiplied with corresponding peak samples of the input signal to reduce the peak of the input signal below a desired threshold. However, multiplying the input signals in the time domain is equivalent to convolving the spectrum of the input signal with the spectrum of the attenuating scheme in the frequency domain. Thusly, while attempting to reduce the splatter and the PAR of the input signal, this known technique alters the spectrum of the clipped signal, thereby introducing undesirable spectrum spreading. Consequently, this known hardlimiting technique fails to adequately address the problems of the reducing the PAR of an input signal while also preserving the signal integrity within the error vector measurements of the applicable wireless standard (e.g., CDMA or UMTS) for the receiver of the transmitted signal.

### SUMMARY OF THE INVENTION

The present invention provides a softlimiting or soft clipping technique for reducing the PAR of an input signal without generating significant out-of-band emissions by clipping peaks above a threshold. The input signal may be a composite signal having one or more information bearing signals respectively centered at carrier frequencies therein. In accordance with the invention, at least one window is created from a set of samples of the input signal to allow at least the highest signal peak to be located therein. For the purposes of the present invention, peak refers to a value above and/or below a preset and/or predetermined value and/or threshold. Once found, the highest signal peak for that window may be compensated for by adding a threshold-correcting signal therewith. A number of windows may be iterative be created from the set, such that the highest signal peak may be located and compensated for by a corresponding threshold correcting signal. Consequently, each found highest peak for each created window may be summed with its corresponding threshold-correcting signal at the location of that highest peak.

### BRIEF DESCRIPTION OF THE DRAWINGS

The present invention will be better understood from reading the following description of non-limiting embodiments, with reference to the attached drawings, wherein below:

FIG. 1 depicts a first application of the present invention;

FIG. 2 depicts an embodiment of the present invention;

FIGS. 3(a) and 3(b) depict others embodiment of the present invention; and

FIG. 4 depicts a flow chart of yet another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention pertains to a scheme for reducing the Peak to Average ratio (“PAR”) of input signals without generating significant out-of-band emissions. By PAR, we refer to the ratio of the peak input signal power to the average input signal power. Using a power amplifier, these input signals are driven into a carrier medium designed for wireless or wired systems. One key element affecting the cost and design of such systems is the power amplifier. While typically set to operate at a predetermined average power, power amplifiers are designed to amplify the peak power required by the input signal. However, a power amplifier operates with increasing efficiency as the input signals to be amplified have a decreasing PAR. Softlimiting the input signals provides one technique for decreasing PAR, and therefore, increasing efficiency of the power amplifier. However, minimizing out-of-band emissions without a drop-off in the efficiency of the power amplifier using these known hardlimiting techniques are of increasing concern.

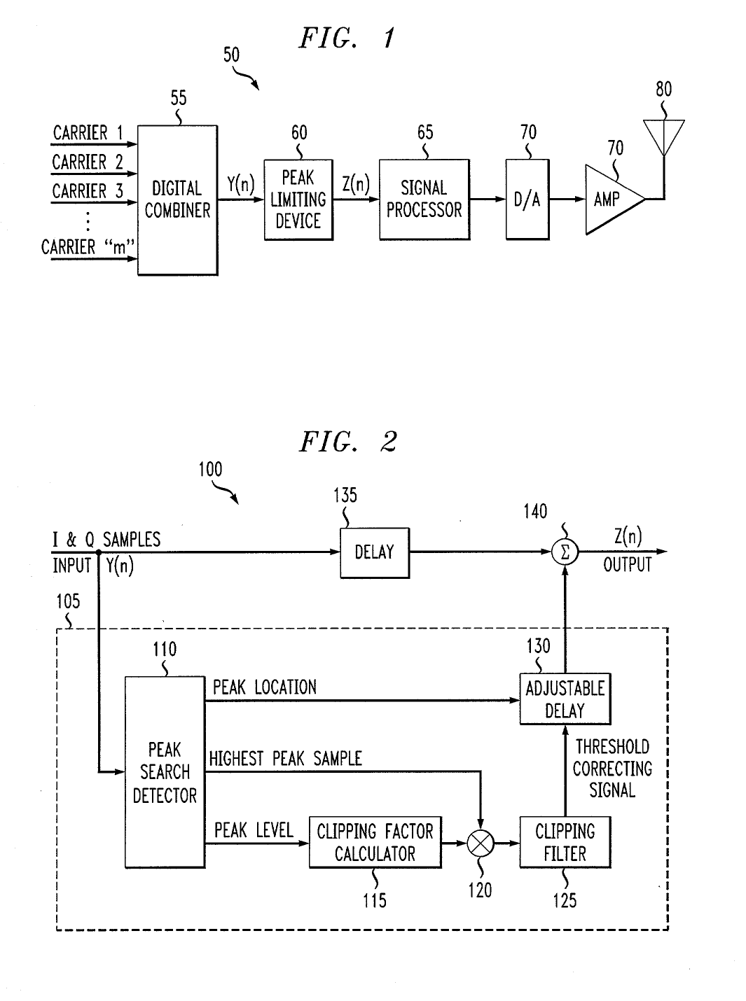

Referring to FIG. 1, a system 50 is illustrated employing the present invention, the details of which will be disclosed hereinbelow. As shown, system 50 is configured to transmit analog signals for wireless applications. It should be apparent to skilled artisans, however, that the system 50 may be designed for wired applications, including telephone or cable networks, for example.

System 50 receives multiple carriers—carrier 1 through carrier m—as inputs. Alternatively, it should be noted that system 50 might receive a single carrier as an input to employ the principles of the present invention. Each multiple carrier input is received by a digital combiner 55, which combines the carriers and forms a composite signal. This composite signal is then processed by a peak limiting device 60, in accordance with the present invention. Peak limiting device 60 compensates for at least the highest peak above a designated or predetermined threshold found within a window of samples. In so doing, peak limiting device 60 reduces the PAR of an input signal using a spectrally matched softclipping technique, for example, thereby minimizing out-of-band emissions without a drop-off in the efficiency of at least one power amplifier 75. The resultant output of peak limiting device 60 may be thereafter signal processed by a signal processor 65, and then converted from digital samples to an analog signal through a D/A converter 70. The analog signal generated by D/A converter 70 is then fed to at least one power amplifier 75 for transmission through at least one antenna 80.

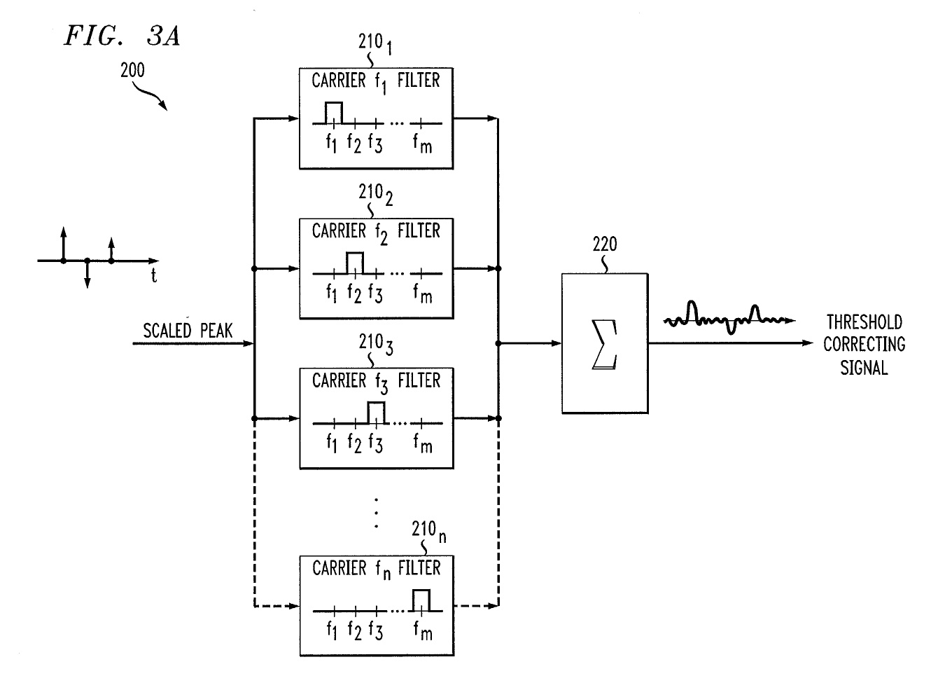

Referring to FIG. 2, an embodiment of the present invention is illustrated. More particularly, a peak limiting architecture 100 is depicted. Peak limiting architecture 100 increases the efficiency of a power amplifier, for example, over the known solutions without increasing out-of-band emissions. In that regard, peak limiting architecture 100 may realize the functionality of peak limiting device 60 of FIG. 1, for example, in accordance with the principles of the present invention, while introducing minimal signal modifications within the error vector measurements of the applicable wireless standard (e.g., CDMA or UMTS).

Peak limiting architecture 100 receives a composite signal, Y(n), as an input. Composite signal, Y(n), comprises a series of input samples, which may be reflective of a series of complex numbers—in-phase and quadrature-phase components, I and Q, respectively—for example. More particularly, composite signal, Y(n), comprises at least one distinct modulated information-bearing carrier. In one example of the present invention, composite signal, Y(n), comprises m number of distinct carriers—reflected as carrier 1 through carrier m. Here, these distinct carrier signals are digitally combined to form the composite signal, Y(n). It should be noted that the peaking statistics of composite signal, Y(n), might be controlled by peak limiting architecture 100.

Peak limiting architecture 100 comprises a peak compensating device 105. In response to receiving the composite signal, Y(n), peak search compensating device 105 initially creates a window of samples from a first set of samples of the composite signal, Y(n). For the purposes of the present disclosure, a window of samples is a subset of the set of received samples. In an illustrative example, the first set may comprise 1,000 samples, while each window may comprise eight (8) consecutive samples.

It should be noted that the length or size (e.g., the number of samples) of each window might be determined by various methods. One such technique involves using a time interval for sizing the window, for example. Here, the number of samples placed within a window during a time interval corresponds with the size of the window. The initiation of the window using this scheme may be triggered by various techniques, including the reception of a peak exceeding the target level or threshold, for example. Alternatively, the size of the window may be pre-determined. Here, each window has a designated number of samples therein. Upon reviewing the instant disclosure, however, numerous alternative techniques for determining the length of a window will become apparent to skilled artisans.

Peak compensating device 105 comprises a peak search detector 110. Peak search detector 110 searches for the highest peak within the window of samples, once a window of samples is formed. It should be noted that each window of samples may have no peaks, or alternatively, each window may have more than one peak. Peak search detector 110 may contemplate and compare each sample having a peak within that window to ascertain the highest peak. Consequently, peak search detector 110 finds at least the highest peak within the window.

Once at least the highest peak is found within the window, peak search detector 110 determines the location and magnitude of the found the peak(s). This determination may be derived as a result of finding at least the highest peak from the window of samples, or performed independently (e.g., in parallel). As a result, peak search detector 110 outputs the peak magnitude or level, the peak sample (e.g., the highest peak within the window), and the location of the peak.

Peak compensating device 105 also comprises a clipping factor calculator 115. In response to receiving the peak magnitude or level from peak search detector 110, clipping factor calculator 115 calculates the appropriate fraction necessary to reduce the found peak to the predetermined threshold level. Clipping factor calculator 115 may be realized by a look up table, though alternatives will be apparent to skilled artisans upon reviewing the instant disclosure.

Additionally, peak compensating device 105 comprises a multiplier 120. Multiplier 120 receives the appropriate fraction determined by calculator 115, as well as the peak sample detected by peak search detector 110. As a result, multiplier 120 generates a clipping factor calculated complex number(s). This clipping factor calculated complex number(s) is then fed into a clipping filter 125, which generates a threshold-correcting signal that insures the signal output from peak limiting architecture 100 is without significant out-of-band emissions. Clipping filter 125 may be realized by various schemes, including a finite impulse response (“FIR”) design. Peak compensating device 105 may be designed such that clipping filter 125 only receives peak samples requiring a threshold-correcting signal. The threshold correcting signal has a sufficient magnitude and polarity to reduce the highest peak found within the window to the predetermined threshold value, or, alternatively, below the predetermined threshold value.

Peak limiting architecture 100 also comprises a delay 135 and a summing device 140. Delay 135 provides a delay corresponding with the time necessary to create the threshold-correcting signal by peak compensating device 105. In response to receiving the window of samples, as delayed by delay 135, and the threshold correcting signal as inputs, summing device 140 generates an output, Z(n). Output, Z(n), may be characterized as the sum of the both of these inputs, wherein at least the highest peak within the window is compensated for and reduced to or below the predetermined threshold. Consequently, the threshold-correcting signal is time aligned with the highest peak sample within the window.

To insure that the threshold-correcting signal is added at the appropriate location of the peak sample within the window, peak compensating device 105 may also comprise an adjustable delay 130. Adjustable delay 130 delays the threshold-correcting signal with respect to summing device 140. This adjustable delay functionally corresponds with the location of the detected peak within the window.

In one example of the present embodiment, composite signal, Y(n), comprises m number of distinct modulated carriers—reflected as carrier 1 through carrier m. Here, these distinct carriers are digitally combined to form the composite signal, Y(n). Each distinct carrier may have a base-band signal, X₀(n), X₁(n), . . . Xₘ₋₁(n), associated therewith, where n is a sampling instant within a sampling period, T. In forming each of the input samples, a sampling rate is selected to be sufficiently high to prevent aliasing in the composite signal. If the frequencies for the carriers are f₀, f₁, . . . fₘ₋₁, respectively, then the sampling rate (1/T) for the signals should be about at least 2*(fₘ₋₁−f₀). Consequently, the composite signal in baseband may be expressed by following mathematical formula:

$$Y ( n ) = {\sum }_{i = 0}^{M - 1} {X}_{i} ( n ) exp ( j {φ}_{i} n )$$

where φᵢ=2*π*(fᵢ−f₀)*T is the phase rotation per sample for the carrier i. Consequently, the peaking statistics of composite signal, Y(n), may be controlled by peak limiting architecture 100.

In this example, the composite signal, Y(n), may have a selected target PAR, λ. The highest peak is located by peak search detector 110 by monitoring if |Y(n)|²>λ. If a |Y(n)|² is greater than X for a pre-determined number of consecutive values of n, then |Y(n)|² (e.g., local extrema) is selected as the sample corresponding with the highest peak. Correspondingly, the clipping fraction may be expressed by the following equation:

$$γ = 1 - \frac{\sqrt{λ}}{\vert Y ( k ) \vert}$$

where γ is the clipping fraction, and the peak found within composite signal, Y(n), is located at n=k.

Additionally, in this example, a peak search window parameter may also be employed. In a window length equal to a pre-selected number of samples, the most prominent or local extrema (e.g., peak) is selected as the sample corresponding with the highest peak. Consequently, the highest local extrema (e.g., highest peak) positioned within a relatively small window length is compensated for selected by peak compensating device 105. It should be noted that any remaining extrema (e.g., peaks) in the samples after compensating for the highest peak might be addressed by undergoing at least one more iteration through peak compensating device 105.

Moreover, the threshold correcting signal is added to the composite signal around the found peak at n=k, in the present example. The clipped composite signal may be thusly expressed as:

Y′(n)=Y(n)−γY(k)W(n−k), n=k−L, . . . , k−1, k, k+1, . . . k+L where W(n), n=−L, −L+1, . . . L−1, L, are the clipping filter coefficients of length 2*L+1, corresponding with the filter shape generated for peak suppression. This procedure is repeated for every new peak that is found. It should be noted that several iterations of the peak location and peak clipping may be performed by peak limiting architecture 100, depending on the requirements for resulting PAR and the degree of clipping noise that may be tolerated. It should be noted that the window size might be reduced to minimize the complexity in implementation. Nonetheless, softlimiting the peaks may reduce or create secondary peaks in the signal, which maybe refined through the iterative approach.

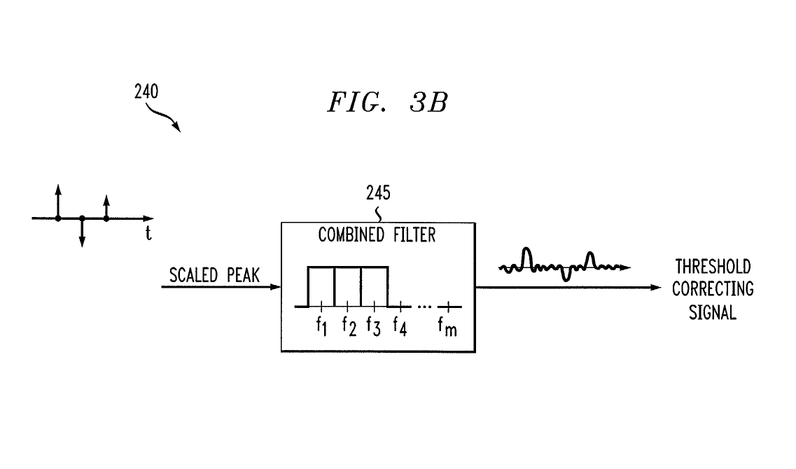

Referring to FIGS. 3(a) and 3(b), another embodiment of the present invention is illustrated. More particularly, a first and second clipping filter system 200 and 240 are shown, much like clipping filter 125 employed in FIG. 2. The threshold-correcting signal is generated by either clipping filter system 200 or 240 in response to the detection of at least the highest peak within a window.

Referring to FIG. 3(a), clipping filter system 200 comprises m number of carrier filters—carrier filter 210₁, carrier filter 210₂ through carrier filter 210ₘ, as composite signal, Y(n), may comprise m number of distinct carriers (e.g., carrier 1 through carrier m). Each carrier filter comprises a finite impulse response, receiving scaled peaks as inputs and having a spectrum centered at the frequency of the corresponding carrier it would pass if realized by a lowpass filter. Consequently, carrier filter 210₁ receives carrier 1 and has a frequency spectrum centered around carrier frequency fi, carrier filter 210₂ receives carrier 2 and has a frequency spectrum centered around carrier frequency f₂, and carrier filter 210ₘ receives carrier m and has a frequency spectrum centered around carrier frequency fₘ. Clipping filter system 200 further comprises a summer 220 for summing the outputs of each carrier filter 210₁ through 210ₘ, thereby to generating the threshold-correcting signal. By this configuration, clipping filter system 200 may have the same spectral quality as the initial signal, thereby avoiding leakage and out-of-band spectral artifacts.

Referring to FIG. 3(b), clipping filter system 240 comprises a combined carrier filter 245. Combined carrier filter 245 comprises a finite impulse response, receiving scaled peaks as inputs and having a spectrum centered at the frequency of the corresponding carrier it would pass if realized by a lowpass filter. Consequently, combined carrier filter 245 receives carrier 1 through m and has a frequency spectrum centered around carrier frequencies f₁ through fₘ. As an integrated realization, combined carrier filter 245 generates the threshold-correcting signal directly. By this configuration, clipping filter system 240 may have the same spectral quality as the initial signal, thereby avoiding leakage and out-of-band spectral artifacts.

In one example of the present embodiment, each carrier corresponds with at least one carrier low-pass filter. Here, each low-pass filter provides a cutoff to the signal outside the passband of the corresponding carrier frequency. Consequently, each low-pass filter has a set of coefficients, which may be expressed for carrier m as follows:

hₘ(n), n=−L, −L+1, . . . , L−1, L

where each filter has a pre-selected length of 2*L+1. Each of the filters may be designed for the same sampling rate as the composite signal to be peak-limited. The band-matched filter for the carrier may be generated by a suitable complex rotation of the low-pass coefficients, which are then added over the carriers to obtain the final clipping filter. Consequently, clipping filter systems 200 and/or 240 may be expressed for m=0, 1, . . . M−1 carriers, as follows:

$$H ( n ) = {\sum }_{i = 0}^{M - 1} {h}_{i} ( n ) exp ( j {φ}_{i} n ) , n = - L , - L + 1 , … , L - 1 , L .$$

The spectrum of the signal generated by clipping filter systems 200 and/or 240 corresponds to the transmit spectrum for the composite signal, and hence the undesirable spectral components may be minimized if this pulse shape is added to the signal. In order to perform the windowed peak limiting, the final clipping filter coefficients for peak limiting may be obtained by normalizing the center tap to unity. However, in one example, the complex coefficients with the frequency translations (hₜ(n) exp(jφₜ,n)), may be pre-stored for all carriers, and added for only the active carriers based on the active configuration. It should be noted that the length of the correction signal for a peak might exceed the search window in which case an additive superposition of the correction signals is achieved by the iterative process.

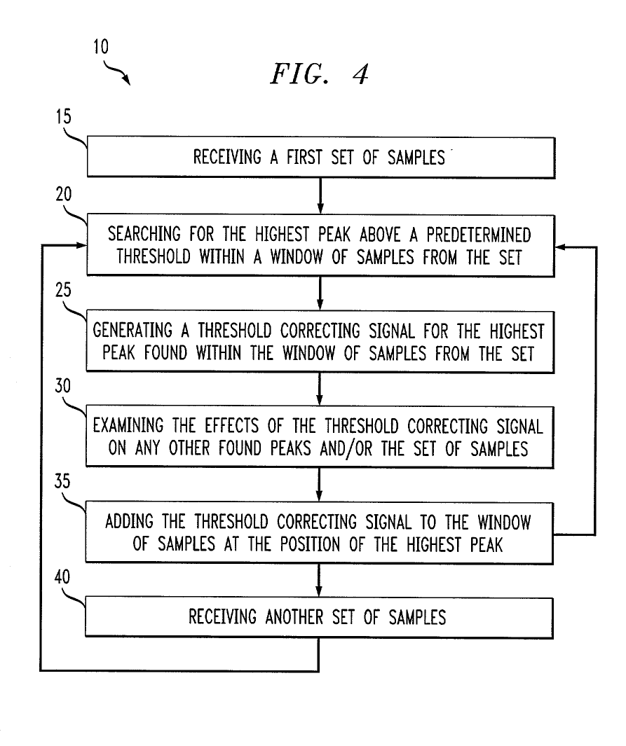

Referring to FIG. 4, a flow chart of another embodiment of the present invention is illustrated. Here, a method (10) for peak limiting is shown. This is method minimizes out-of-band emissions without a drop-off in the efficiency of the power amplifier. More particularly, this peak limiting method compensates for at least the highest peak above a designated or predetermined threshold found within a window of samples is shown. These samples may be composite, digitally combined and/or complex numbers (e.g., I and Q). For the purposes of the present disclosure, the term peak refers to a sample and/or samples that rise above a predetermined threshold (e.g., amplitude or voltage). The predetermined threshold is selected to reduce the PAR of an input signal using the softlimitng technique, for example, and may be varied at any point during the execution of the present method.

In accordance with the method, initially, a first set of samples is received (15). From this first set of samples, the method searches for the highest peak above the predetermined threshold (20). More particularly, this step involves searching for the highest peak within at least one window of samples created from the received first set though. For the purposes of the present disclosure, a window of samples is a subset of the set of received samples. For example, the first set may comprise 1,000 samples, while each window may comprise eight (8) samples. It should be noted that each window of samples might have no peaks, or alternatively, have more than one peak. As such, this searching step contemplates and compares each sample having a peak within that window to ascertain the highest peak. As will be detailed hereinbelow, each of the first set of samples is examined using these window creating and peak searching process steps.

After the highest peak is searched and found within the window of samples, a threshold-correcting signal is generated (25). This threshold correcting signal has a sufficient magnitude and polarity to reduce the highest peak found within the window to the predetermined threshold value, or, alternatively, below the predetermined threshold value. Consequently, the threshold-correcting signal may be viewed as having inverse characteristics to the found highest peak.

Once the threshold-correcting signal is generated, the method examines the effects of adding the threshold-correcting signal to the highest peak (30). More particularly, the effects of adding the threshold-correcting signal on any other peaks found within the window are examined by this step. This examination involves assessing whether oscillations may be created by adding the threshold-correcting signal to the highest peak detected within the present window. These oscillations may create undesirable distortion within the output produced by the present method. Here, undesirable distortion may include out-of-band emissions and spectrum spreading, for example. This step may also examine the effects of the threshold-correcting signal on the previous window of samples, as well as the subsequent window of samples. Alternatively, the effects of the threshold-correcting signal on the entire first set of sample may be examined by this step to insure that undesirable distortion is not created within the output.

Subsequently, the threshold-correcting signal is added to the highest peak within the window (35) after the effects of the threshold-correcting signal have been examined. By adding the threshold-correcting signal to the highest peak, the location of the highest peak within the window may be necessary to ensure that the threshold-correcting signal is added to the correct sample within the window. The sum of the threshold correcting signal and the sample within the window having the highest peak causes that sample to fall at or below the predetermined threshold to reduce the PAR of the input signals.

As stated herein, the effects of adding the threshold-correcting signal are examined prior to performing the step of adding the threshold-correcting signal. The sequence of these steps is representative of one example of the present embodiment. Alternatively, the step of adding the threshold-correcting signal to the highest peak within the window (35) may be performed prior to examining the effects of adding the threshold-correcting signal to the highest peak (30).

Once the highest peak within the first window is found and compensated for by generating the threshold-correcting signal, a subsequent window is formed from the remaining samples of the first set. This process may, as such, continue iteratively until all of the samples of the first set have undergone the steps detailed hereinabove. Likewise, once the first set of samples has been, for example, searched window by window for the highest peak of the samples, and a threshold correcting signal generating for each corresponding window, another set of sample are received (40), and the process continues, window by window, until all of the samples of this next set have undergone the steps detailed hereinabove.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method for softlimiting a signal comprising:
searching for at least one peak above a threshold within a first window created from a set of samples of the signal; and
adding a threshold correcting signal to the at least one peak found by the step of searching for at least one peak.

2. The method of claim 1, wherein the found at least one peak comprises the highest peak within the window.

3. The method of claim 2, wherein the signal is a composite signal comprising more than one carrier frequency, and further comprising:
examining the composite signal after adding the threshold-correcting signal to the found highest peak to determine if at least another found peak within the first window has been reduced below the threshold and/or at least one unwanted oscillation has not been introduced into the composite signal by the threshold-correcting signal.

4. The method of claim 3, wherein the step of examining the composite signal comprises:
if the at least another peak has not been reduced below the threshold and/or the at least one unwanted oscillation has been introduced into the composite signal by the threshold correcting signal,
searching for the at least another peak within the first window of samples created; and
adding another threshold correcting signal to the at least another peak found by the step of searching for the at least another peak.

5. The method of claim 3, further comprising:
continuing to search for more peaks within the first window, correspondingly adding threshold correcting signals for each of the more peaks found and examining the composite signal until the samples within the first window are below the threshold.

6. The method of claim 3, further comprising:
searching for at least one additional highest peak above the threshold within a second window created from the set of samples created;
adding an additional threshold correcting signal to the at least one additional highest peak found by the step of searching for at least one additional highest peak; and
examining the composite signal again after adding the additional threshold correcting signal to the at least one additional found highest peak to determine if at least another additional found peak within the second window has been reduced below the threshold and/or at least one unwanted oscillation has not been introduced into the composite signal by the additional threshold correcting signal.

7. The method of claim 6, wherein the step of examining the composite signal again after adding the additional threshold-correcting signal comprises:
if the at least another additional peak has not been reduced below the threshold and/or the at least one unwanted oscillation has been introduced into the composite signal by the additional threshold correcting signal,
searching for the at least another additional peak within the second window of samples created; and
adding another additional threshold correcting signal to the at least another additional peak found by the step of searching for the at least another additional peak.

8. The method of claim 7, further comprising:
continuing to search for more additional peaks within the second window, correspondingly adding threshold-correcting signals for each of the more additional peaks found and examining the composite signal until the samples within the second window are below the threshold.

9. A system comprising:
an amplifier for amplifying a signal; and
a peak compensating device comprising:
a peak search detector for detecting the presence of at least a highest peak above a threshold within a window of samples; and
a clipping filter for generating a threshold-compensating signal in response to detecting the presence of at least a highest peak.

10. The system of claim 9, wherein the signal is a composite signal comprising more than one carrier frequency, and further comprising:
a delay device for time aligning the threshold compensating signal relative to the at least a highest peak; and
a summing device for summing the threshold-compensating signal with the composite signal.

11. The system of claim 9, wherein the peak compensating device comprises:
a clipping factor calculator for calculating a magnitude and a polarity of the threshold compensating signal for the clipping filter; and
a multiplier for multiplying the at least a highest peak with the calculated magnitude and polarity.

12. The system of claim 10, wherein the clipping filter comprises at least one carrier filter for obtaining a sum of finite impulse responses for each carrier frequency of the composite signal.

13. The system of claim 10, wherein the clipping filter comprises one carrier filter for each carrier frequency of the composite signal, at least one of the carrier filters being weighted differently than the remaining carrier filters to control the in-band correction signal power.

14. The system of claim 13, wherein the weighting of the at least one of the carrier filter for the different carriers causes the in-band correction signal power to be distinct for each carrier frequency.

15. The system of claim 9, wherein the window of samples comprise at least one of I and Q information.

16. A method for clipping peaks of a composite signal, the method comprising:
searching for a first highest peak above a threshold within a first window created from a set of samples of the signal;
calculating a magnitude and polarity of a threshold-correcting signal for the first highest peak;
examining the characteristics of the composite signal if the threshold correcting signal is added to the first highest peak; and
adding the threshold-correcting signal with the first window of samples at the position of the first highest peak found by the step of searching for a first highest peak.

17. The method of claim 16, wherein the step of adding the threshold correcting signal is performed if at least one of the following are determined by the step of examining the characteristics of the composite signal:
another peak within the window has been reduced below the threshold; and
at least one unwanted oscillation has not been introduced into the composite signal by the threshold-correcting signal.

18. The method of claim 17, further comprising:
searching for a second highest peak above the threshold within a second window created from the set of samples;
calculating a second magnitude and a second polarity of the second threshold-correcting signal for the second highest peak;
examining the characteristics of the composite signal if the second threshold correcting signal is added to the second highest peak found within the second window; and
adding the second threshold correcting signal to the second highest peak found by the step of searching for a second highest peak within the second window; and
examining the composite signal again after adding the second threshold-correcting signal to the second highest peak.

19. The method of claim 18, the step of examining the composite signal again after adding the second threshold-correcting signal comprises:
if at least another additional found peak within the second window has not been reduced below the threshold and/or at least one unwanted oscillation has been introduced into the composite signal by the second threshold correcting signal,
searching for the at least another peak within the second window of samples created; and
adding another threshold correcting signal to the at least another additional peak found by the step of searching for the at least another additional peak.

20. The method of claim 19, further comprising:
continuing to search for more peaks within the at least one of the first and the second windows, correspondingly adding more threshold correcting signals for each of the more peaks found and examining the composite signal until the samples within the at least one of the first and the second windows are below the threshold.
